(19) United States
(12) Patent Application Publication
(10) Pub. No.: US 2015/0084919 A1
(43) Pub. Date: Mar. 26, 2015

(54) Information Input Device

(71) Applicant: Brother Kogyo Kabushiki Kaisha, Nagoya-shi (JP)

(72) Inventors: Yoshihiko Sugimura, Nagoya-shi (JP); Yuji Iida, Chita-shi (JP)

(21) Appl. No.: 14/482,019

(22) Filed: Sep. 10, 2014

(30) Foreign Application Priority Data
Sep. 24, 2013 (JP) 2013-197504

(51) Int. Cl. G06F 3/0354; G06F 3/046

(52) U.S. Cl. CPC G06F 3/03545; G06F 3/046
USPC 345/174

(57) ABSTRACT

An information input device having a sensor portion and a processor. The sensor portion generates an output corresponding to a position of a writing tool inside a predetermined detection area. The processor acquires position information based on an output of the sensor portion and stores trajectory information in a storage medium. The processor determines whether the position of the writing tool corresponding to the acquired position information is included in a second area obtained by excluding a first area from the detection area. The first area is an area of a predetermined width along an outer edge of the detection area. The processor prohibits processing that adds the acquired position information to the trajectory information and stores the updated trajectory information, when it is determined that the position of the writing tool corresponding to the acquired position information is not included in the second area.

### CROSS-REFERENCE TO RELATED APPLICATION

This application claims priority to Japanese Patent Application No. 2013-197504 filed on Sep. 24, 2013, the disclosure of which is herein incorporated by reference in its entirety.

### BACKGROUND

The present disclosure relates to an information input device that is capable of acquiring information that has been input using a writing tool on a recording medium, such as paper, as digitized information.

In known art, an information input device is known that can digitize written content, using a digitizer, when characters or graphics etc. are written on a paper medium (a booklet-like recording medium that is formed of a plurality of sheets that are bound together, for example) using a writing tool. More specifically, for example, this type of device is configured so that a movement trajectory of the writing tool on the paper medium that is placed on a pad is read by a digitizer provided in the pad. For example, in this type of known device, an electromagnetic induction type tablet is provided as the digitizer. The electromagnetic induction type digitizer can detect a position at which the writing tool comes into contact with or comes close to a detection surface of the digitizer, convert the detected position to coordinate data, taking the detection surface as an XY plane, and output the coordinate data to the information input device. By sampling the coordinate data output by the digitizer, the information input device can acquire trajectory information, which is an aggregate of the coordinate data that can reproduce the movement trajectory of the writing tool.

### SUMMARY

However, the electromagnetic induction type digitizer can detect not only the position at which the writing tool comes into contact with the detection surface, but also the position at which the writing tool comes close to the detection surface. As a result, when the digitizer detects the position of the writing tool in a state in which the writing tool is positioned outside the detection surface, there is a possibility that when the trajectory is reproduced based on trajectory information, noise-like points and lines are drawn on an outermost peripheral portion of the XY plane.

Various exemplary embodiments of the general principles described herein provide an information input device that can acquire accurate trajectory information, by not including acquired position information in the trajectory information when a writing tool is positioned outside a predetermined area, which is an area that is obtained by excluding, from a detection area, an area of a predetermined width along an outer edge of the detection area.

Exemplary embodiments herein provide an information input device having a sensor portion and a processor. The sensor portion is configured to generate an output corresponding to a position of a writing tool inside a predetermined detection area, in the course of writing that is performed on a recording medium using the writing tool, the recording medium being set on the information input device such that the recording medium corresponds to the detection area. The processor is configured to acquire position information based on the output of the sensor portion, the position information being information corresponding to the position of the writing tool. The processor is also configured to store trajectory information in a storage medium. The trajectory information is formed of a series of the position information as a result of chronologically storing the acquired position information in the storage medium. Specifically, the trajectory information is information corresponding to a trajectory of writing performed using the writing tool. The processor is also configured to determine whether the position of the writing tool corresponding to the acquired position information is included in a second area, which is an area obtained by excluding a first area from the detection area. The first area is an area of a predetermined width along an outer edge of the detection area. The processor is also configured to prohibit processing that adds the acquired position information to the trajectory information and stores the updated trajectory information, when it is determined that the position of the writing tool corresponding to the acquired position information is not included in the second area. The processor is also configured to perform processing that adds the acquired position information to the trajectory information and stores the updated trajectory information, when it is determined that the position of the writing tool corresponding to the acquired position information is included in the second area.

### BRIEF DESCRIPTION OF THE DRAWINGS

Exemplary embodiments will be described below in detail with reference to the accompanying drawings in which:

FIG. 1 is a perspective view of an information input device 1;

FIG. 2 is a partial plan view of the information input device 1;

FIG. 3 is a block diagram showing an electrical configuration of the information input device 1;

FIG. 4 is a flowchart of main processing; and

FIG. 5 is a diagram illustrating relationships between an effective area P and stroke data M1, M2 and M3.

### DETAILED DESCRIPTION

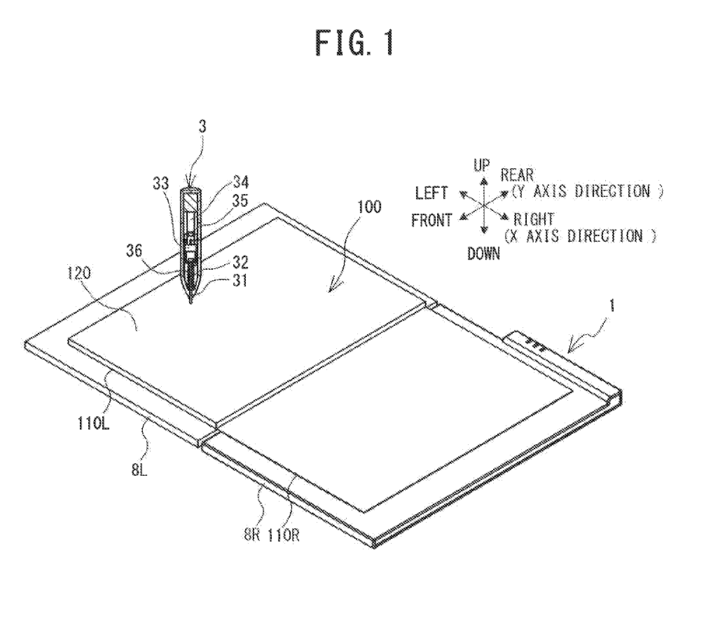

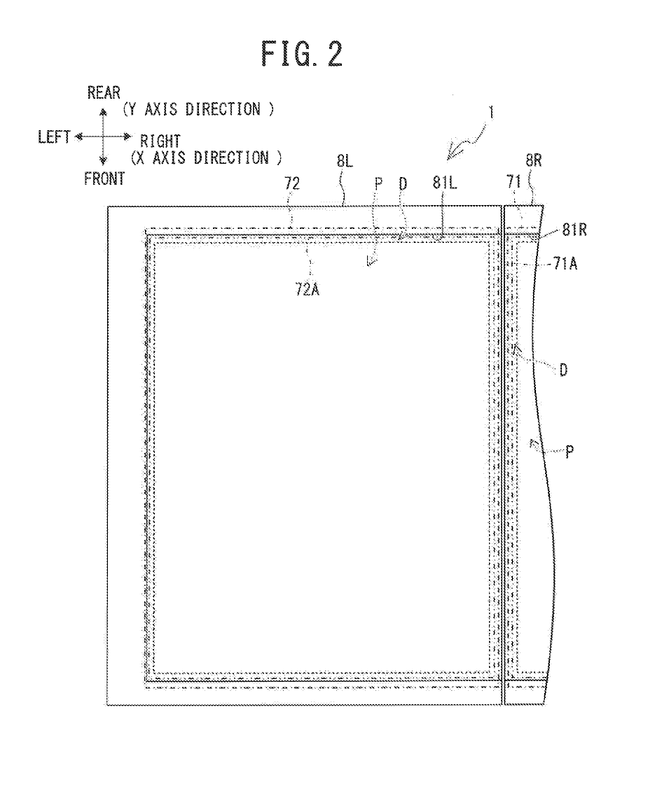

Hereinafter, an embodiment will be explained with reference to the drawings. The drawings referred to are used to illustrate technological features that can be adopted by the present disclosure. Device configurations and flowcharts of various processing etc. shown in the drawings are merely explanatory examples and are not intended to limit the present disclosure to only those examples. An overview of an information input device 1 according to a present embodiment will be explained with reference to FIG. 1 and FIG. 2. In the following explanation, the upper left side, the lower right side, the upper side, the lower side, the lower left side and the upper right side of FIG. 1 respectively define a left side, a right side, an upper side, a lower side, a front side and a rear side of the information input device 1.

The information input device 1 is a thin, lightweight handwriting input device. The information input device 1 is configured to detect and digitize positions of an electronic pen 3 over time when a user uses the electronic pen 3 to write information on a paper medium 100 that is mounted on the information input device 1. The information input device 1 is provided with housings 8L and 8R. The housings 8L and 8R are made of synthetic resin, and each is formed as a thin rectangular plate. The information input device 1 is configured so that the housings 8L and 8R can be changed between a folded over state that is not shown in the drawings, and a state in which they are open in a two-page spread in the left-right direction, as shown in FIG. 1.

In the state in which the housings 8L and 8R shown in FIG. 1 are in the open two-page spread state in the left-right direction, the paper medium 100 is fixed to upper surfaces (which can also be referred to as front surfaces as they are the surfaces on the side facing the user) of the housings 8L and 8R.

In the present embodiment, the paper medium 100 is a booklet shaped medium that can be opened out to a two-page spread in the left-right direction. The paper medium 100 is formed of a pair of cover sheets (a front cover sheet 110L and a back cover sheet 110R) and a plurality of paper sheets 120 that are bound together at their respective edge portions. As an example, the paper medium 100 is an A5 size notebook. In a specific example corresponding to FIG. 1, the paper medium 100 is mounted on the information input device 1 such that the front cover sheet 110L is placed on the upper surface of the housing 8L and the back cover sheet 11OR is placed on the upper surface of the housing 8R. When the paper medium 100 is mounted on the information input device 1, the user can use the electronic pen 3 to write information on the paper sheet 120. The information input device 1 is configured to detect position information of the electronic pen 3 that is being used to write the information on the paper sheet 120, using a sensor board 71 or a sensor board 72 (the sensor boards 71 and 72 will be explained in more detail later) that is housed inside the housing 8L or 8R that corresponds to the paper sheet 120 on which the electronic pen 3 is being used to write the information.

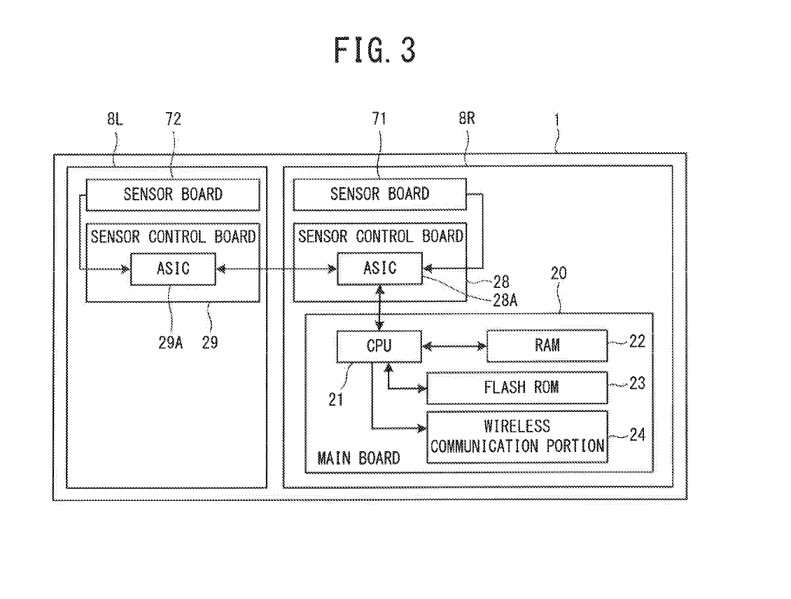

As shown in FIG. 2, position determining portions 81L and 81R are respectively formed on the upper surfaces (the front surfaces) of the housings 8L and 8R. The position determining portions 81L and 81R are recessed portions that are formed in order to provide a positioning function when the front cover sheet 110L and the back cover sheet 11OR of the paper medium 100 are respectively fixed to the housings 8L and 8R. The housing 8R houses the sensor board 71, a sensor control board 28 and a main board 20 (refer to FIG. 3). The housing 8L houses the sensor board 72 and a sensor control board 29 (refer to FIG. 3). As will be explained in more detail later, each of the sensor boards 71 and 72 is formed in a substantially rectangular flat plate shape in a plan view. The sensor boards 71 and 72 are sensors that detect, by an electromagnetic induction method, a position of the electronic pen 3 that comes into contact with or comes close to detection areas 71A and 72A that are provided on upper surfaces of the sensor boards 71 and 72. The housings 8L and 8R are configured to house the sensor boards 71 and 72 in a state in which the position determining portions 81L and 81R are respectively arranged in alignment with the detection areas 71A and 72A of the sensor boards 71 and 72.

As shown in FIG. 1, the electronic pen 3 is a known electromagnetic induction-type electronic pen and is provided with a core body 31, a coil 32, a variable capacity condenser 33, a board 34, a condenser 35 and an ink storage portion 36. The core body 31 is provided on the leading end portion of the electronic pen 3. The core body 31 is arranged so as to be urged toward the leading end of the electronic pen 3 by an elastic member that is not shown in the drawings. The core body 31 is also arranged so as to project its tip to the outside of a cylindrical body 30. The rear end of the core body 31 is connected to the ink storage portion 36 in which ink is stored. The ink storage portion 36 is provided to supply the ink to the core body 31. Thus, when the user writes using the electronic pen 3, the written characters (letters, numerals and graphics etc.) are formed on the paper sheet 120 by the ink.

In a state in which the coil 32 is wound around the periphery of the ink storage portion 36, the coil 32 is held between the core body 31 and the variable capacity condenser 33. The variable capacity condenser 33 is fixed to the inside of the electronic pen 3 by the board 34. The condenser 35 is mounted on the board 34. The condenser 35 and the variable capacity condenser 33 are connected in parallel to the coil 32 so as to form a known resonance (tuning) circuit.

An electrical configuration of the information input device 1 will be explained with reference to FIG. 3. The information input device 1 is mainly provided with the main board 20, the sensor boards 71 and 72 and the sensor control boards 28 and 29. As described above, the main board 20, the sensor board 71 and the sensor control board 28 are housed in the housing 8R. The sensor board 72 and the sensor control board 29 are housed in the housing 8L.

The main board 20 is provided with a CPU 21, a RAM 22, a flash ROM 23 and a wireless communication portion 24. The RAM 22, the flash ROM 23 and the wireless communication portion 24 are electrically connected to the CPU 21. The CPU 21 is provided so as to control the entire operation of the information input device 1. The RAM 22 is provided so as to temporarily store various data, such as arithmetic calculation data and the like. The flash ROM 23 is provided so as to store various programs executed by the CPU 21 to perform the control of the information input device 1. Further, the flash ROM 23 is provided so as to store stroke data representing a trajectory of the electronic pen 3 that is used to write information on the paper medium 100. The stroke data is formed by adding header information (a stroke header) to data in which a plurality of pieces of position information (coordinate data, for example) of the electronic pen 3 detected chronologically by the sensor board 71 and the sensor board 72 are arranged in an order of detection. The stroke header includes, for example, data number information representing a number of pieces of coordinate data included in one set of the stroke data and time information representing a time at which the stroke data is generated. In other words, the stroke data is data that can reproduce the information (characters, numerals and graphics etc) written by the user on the paper sheet 120, by connecting the individual pieces of coordinate data along a time series. The wireless communication portion 24 is a controller that is used to perform near-field wireless communication with an external electronic device. Although not shown in the drawings, the information input device 1 can transmit the generated stroke data from a personal computer (PC) or the like that is used by the user, via the wireless communication portion 24.

As described above, the sensor boards 71 and 72 are electromagnetic induction-type sensors, and are configured to detect the position of the electronic pen 3 that comes into contact with or comes close to the detection areas 71A and 72A (refer to FIG. 2). In the sensor boards 71 and 72, a plurality of rectangular loop coils that are arrayed at a predetermined interval in an X axis direction (left-right direction) and a Y axis direction (up-down direction) are arranged inside the detection areas 71A and 72A. The sensor board 71 is electrically connected to an application-specific integrated circuit (ASIC) 28A that is mounted on the sensor control board 28. An antenna resonance circuit (not shown in the drawings) is built into the sensor control board 28. The ASIC 28A controls the sensor board 71 in order to realize an operation to detect the position of the electronic pen 3. The ASIC 28A generates coordinate data, taking the detection area 71A as the XY plane, based on the position of the electronic pen 3 detected by the sensor board 71 when the writing operation using the electronic pen 3 is performed on the housing 8R that houses the sensor board 71.

Similarly, the sensor board 72 is electrically connected to an ASIC 29A that is mounted on the sensor control board 29. An antenna resonance circuit is built into the sensor control board 29. The ASIC 29A controls the sensor board 72 in order to realize an operation to detect the position of the electronic pen 3. The ASIC 29A generates coordinate data, taking the detection area 72A as the XY plane, based on the position of the electronic pen 3 detected by the sensor board 72 when the writing operation using the electronic pen 3 is performed on the housing 8L that houses the sensor board 72. Of the ASIC 28A and the ASIC 29A, the ASIC 28A that is on the master side is directly connected to the CPU 21 and outputs the coordinate data to the CPU 21. The ASIC 29A that is on the slave side is connected to the CPU 21 via the ASIC 28A and outputs the coordinate data to the CPU 21.

Next, the principle of an operation by which the sensor boards 71 and 72 detect the position of the electronic pen 3 (this operation will hereinafter simply be referred to as “scanning”) will be briefly explained. Based on a command of the CPU 21, the ASIC 28A and the ASIC 29A respectively control the sensor control boards 28 and 29. The sensor control boards 28 and 29 generate a magnetic field by causing an electric current of a specific frequency to flow through the plurality of loop coils of the sensor boards 71 and 72. When the electronic pen 3 comes close to the sensor boards 71 and 72 in this state, a resonance circuit of the electronic pen 3 resonates as a result of electromagnetic induction of the loop coils and an induction field is generated.

The sensor control boards 28 and 29 stop the flow of the electric current to the loop coils and scan the loop coils one by one. An electric current generated by the induction field caused by the resonance circuit of the electronic pen 3 flows through the loop coils. The electric current flowing through the loop coil closest to the electronic pen 3 is large, and the electric current flowing through the loop coil that is adjacent to the “loop coil closest to the electronic pen 3” is comparatively small. The sensor control boards 28 and 29 use a differential amplifier circuit (not shown in the drawings) to perform voltage conversion on the electric current flowing through the loop coils of each of the sensor boards 71 and 72, and input the converted voltage to the ASIC 28A and the ASIC 29A. The ASIC 28A and the ASIC 29A calculate the position of the electronic pen 3 based on the input voltage values, convert the position to coordinate data and output the coordinate data to the CPU 21.

When the user is using the electronic pen 3 to write information on the paper medium 100, a writing pressure is applied to the core body 31 of the electronic pen 3. The inductance of the coil 32 varies depending on the writing pressure applied to the core body 31, and thus the resonance frequency of the resonance circuit of the electronic pen 3 changes. The ASIC 28A and the ASIC 29A determine whether or not information is being written on the paper medium 100 by detecting changes in the resonance frequency, namely, phase changes. When the ASIC 28A and the ASIC 29A determine, based on the changes in the resonance frequency, that the user is writing information on the paper medium 100 (when the writing pressure is applied to the electronic pen 3), the ASIC 28A and the ASIC 29A output a pen down signal (a high signal) to the CPU 21. Further, when the ASIC 28A and the ASIC 29A determine, based on the changes in the resonance frequency, that the user is not writing information on the paper medium 100 (the writing pressure on the electronic pen 3 is released), the ASIC 28A and the ASIC 29A output a pen up signal (a low signal) to the CPU 21. When the CPU 21 receives the pen down signal, the CPU 21 generates stroke data by acquiring the coordinate data output by the ASIC 28A and the ASIC 29A and stores the stroke data in the flash ROM 23.

As described above, the position of the electronic pen 3 that comes into contact with or comes close to the detection areas 71A and 72A of the sensor boards 71 and 72 is detected by the electromagnetic induction method. As a result, even when the position of the electronic pen 3 is a position that is outside the detection areas 71A and 72A, there are cases in which the position of the electronic pen 3 is detected. In this case, it is possible that the ASIC 28A and the ASIC 29A may output, as the coordinate data based on a result of scanning the sensor boards 71 and 72, coordinate data representing a position along the side on which the electronic pen 3 moved outside the detection areas 71A and 72A, of the four sides of the detection areas 71A and 72A. In the information input device 1 of the present embodiment, as shown in FIG. 2, an ineffective area D is set around the outer edges of each of the detection areas 71A and 72A. Each of the ineffective areas D has a predetermined width (100 dots, for example, when the coordinate data is expressed as a dot number). At the same time, an area of each of the detection areas 71A and 72A that excludes the ineffective area D is set as an effective area P. By performing main processing that will be explained below, the information input device 1 treats coordinate data that is outside the effective areas P as invalid and generates stroke data represented by an aggregate of coordinate data that is inside the effective areas P.

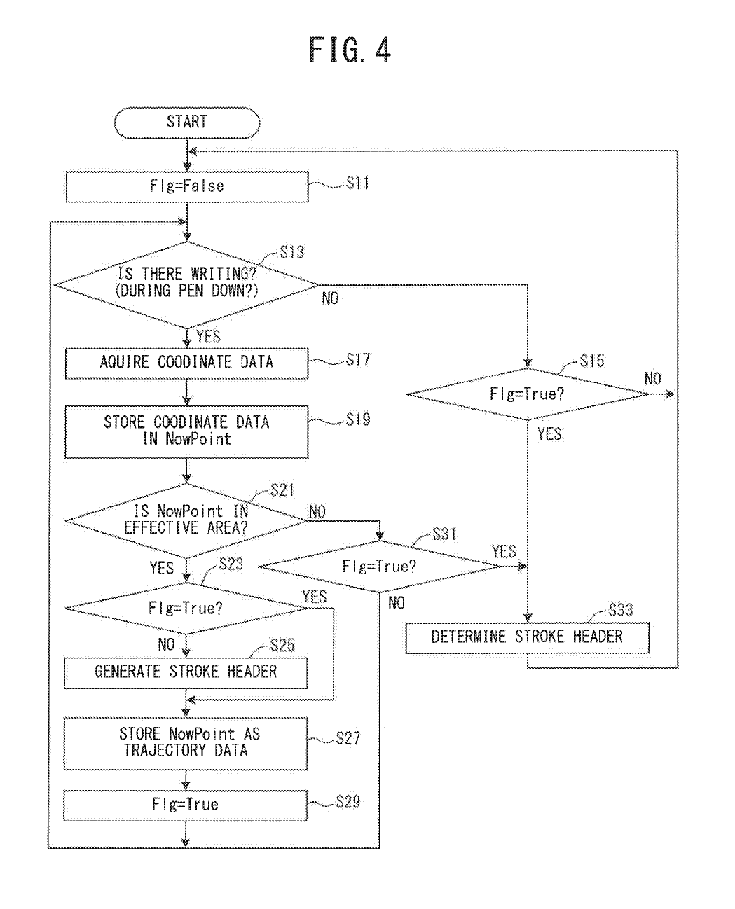

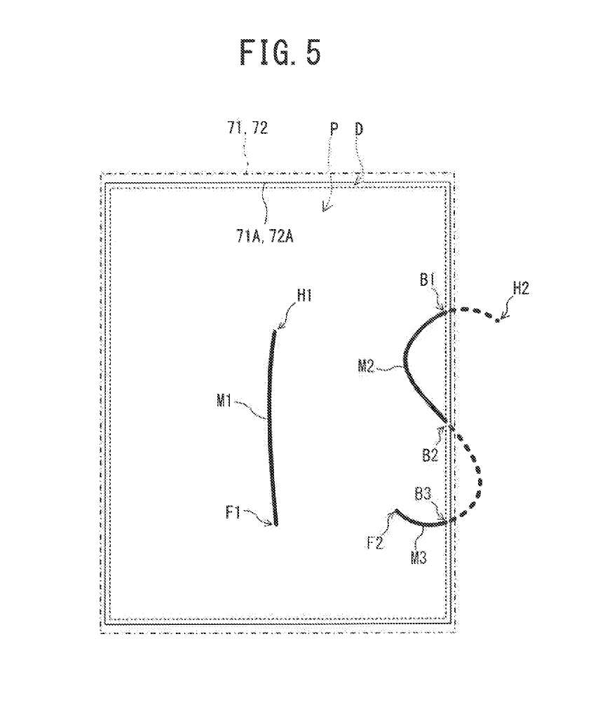

The main processing of the information input device 1 will be explained with reference to FIG. 4 and FIG. 5. When the power source of the information input device 1 is switched on, the CPU 21 supplies power to the sensor boards 71 and 72 from the ASIC 28A and the ASIC 29A, by outputting a command to the ASIC 28A and the ASIC 29A. Specifically, the ASIC 28A and the ASIC 29A start scanning by the sensor boards 71 and 72. The CPU 21 reads the program that is stored in the flash ROM 23 into the RAM 22 and performs the main processing (refer to FIG. 4). At that time, the CPU 21 stores data that is acquired in the course of the processing in the RAM 22, as appropriate.

As shown in FIG. 4, in the main processing, the CPU 21 first performs initialization processing. More specifically, the CPU 21 secures a storage area for the stroke data in the flash ROM 23. Further, the CPU 21 secures a storage area for a variable [NowPoint] and a storage area for a flag [Flg] in the RAM 22, and sets [Flg] to zero (False), as an initial value (step S11). After this initialization processing, the CPU 21 determines whether or not the pen down signal has been received from the ASIC 28A and/or the ASIC 29A (step S13). If the pen down signal has not been received (no at step S13), [Flg] is still False (no at step S15) and thus the processing returns to step S11. The CPU 21 repeats the processing at step S11 to step S15 until the pen down signal is received, and thus waits for the writing of information on the paper medium 100 by the user using the electronic pen 3. When the pen down signal has been received (yes at step S13), the CPU 21 acquires the coordinate data output by the ASIC 28A and/or the ASIC 29A (step S17). Next, the CPU 21 stores the acquired coordinate data in [NowPoint] (step S19).

The CPU 21 determines whether or not the coordinate data stored in [NowPoint] is inside the effective area P (step S21). If the coordinate data of the position at which the user pressed the pen down is inside the effective area P (yes at step S21), the CPU 21 determines whether or not [Flg] is True (step S23). When [Flg] is False (no at step S23), the CPU 21 sets an area to which a stroke header is added in the storage area for the stroke data secured in the flash ROM 23 (step S25). The CPU 21 acquires time information from a clock that is not shown in the drawings, and stores the acquired time information in the stroke header. The CPU 21 adds the coordinate data stored in [NowPoint] to the end of the stroke data and stores the updated stroke data (step S27). The CPU 21 sets 1 (True) for [Flg] (step S29) and returns the processing to step S13. Note that, although not shown in the drawings, when the CPU 21 returns the processing to step S13 after the processing at step S29, the CPU 21 waits for a predetermined period of time to elapse, so that the acquisition of the coordinate data at step S17 is performed periodically.

After this, the user continues to write information in the same manner, and if the coordinate data of the electronic pen 3 is not outside the effective area P (yes at step S21), the CPU 21 continues the processing to add the coordinate data of the electronic pen 3 to the end of the stroke data (step S27). In this case, in the processing at step S23, as [Flg] is set to True by the above-described processing at step S29, the CPU 21 advances the processing to step S27.

When the ASIC 28A and the ASIC 29A have received the pen up signal (no at step S13) while the processing to generate the stroke data is being performed, as [Flg] is True (yes at step S15), the CPU 21 performs processing to determine the stroke header (step S33). The CPU 21 counts up the number of the pieces of coordinate data added to the stroke data, and stores a counted result in the stroke header as the data number information. The CPU 21 ends the generation of the stroke data by confirming the stroke header, and returns the processing to step S11.

The following looks at stroke data M1 shown in FIG. 5 that is generated based on a character “1” written by the user on the paper medium 100 using the electronic pen 3. The user presses the pen down at a point H1 and starts to write the character “1.” The CPU 21 acquires coordinate data of the point H1 (step S17) based on the pen down signal (yes at step S13). The point H1 is inside the effective area P (yes at step S21) and thus the CPU 21 generates a stroke header (step S25), and adds the coordinate data to the stroke data (step S27). The user starts writing the character “1” from the point H1 and reaches a point F1 without going outside the effective area P on the way. As a result, the CPU 21 repeatedly performs the processing at step S13 and step S17 to step S29, and adds the coordinate data that is based on the trajectory of the electronic pen 3 to the stroke data. The user lifts the pen up at the point Fl and ends the writing of the character “1.” The CPU 21 determines the stroke header (step S33) based on the pen up signal (no at step S13) and completes the stroke data M1. In the stroke data M1, both the point H1 and the point F1 are inside the effective area P. Further, in the stroke data M1, between the point H1 and the point F1 there is no section that goes outside the effective area P. As a result, using the stroke data M1, a line segment connecting the point H1 and the point F1 is formed.

As shown in FIG. 4, while the user continues to write information and the CPU 21 continues the processing to add the coordinate data of the electronic pen 3 to the end of the stroke data (step S13, step S17 to step S29), there is a case in which the coordinate data of the electronic pen 3 is outside the effective area P. In this case (no at step S21), the CPU 21 advances the processing to step S31. In a similar manner to the above description, because [Flg] is True as a result of the processing at step S29 (yes at step S31), the CPU 21 advances the processing to step S33 and determines the stroke header (step S33). The CPU 21 ends the generation of the stroke data and returns the processing to step S11. Specifically, at a point in time at which the coordinate data of the electronic pen 3 goes outside the effective area P while the user is writing the information, the CPU 21 generates a single independent set of stroke data based on the information written by the user up to that point.

Even when the user further continues writing the information in a state in which the coordinate data of the electronic pen 3 is outside the effective area P, the ASIC 28A and the ASIC 29A continue to output the pen down signal (yes at step S13). As a result, the CPU 21 acquires the coordinate data and stores the coordinate data in [NowPoint] (step S17, step S 19). As the coordinate data of [NowPoint] is outside the effective area P (no at step S21), the CPU 21 determines whether or not [Flg] is True (step S31). As the CPU 21 set [Flg] to zero (no at step S31) in the processing at step S11 performed when the coordinate data of the electronic pen 3 moved outside of the effective area P, the CPU 21 returns the processing to step S13. The CPU 21 repeats the processing at step S13, step S17 to step S21 and step S31 and stands by until the user finishes writing the information and the pen up signal is received from the ASIC 28A and/or the ASIC 29A (step S13) or until the coordinate data of [NowPoint] enters inside the effective area P (step S21). Then, if the coordinate data of the electronic pen 3 once more enters inside the effective area P (yes at step S21), the CPU 21 generates the stroke header (step S25) and, in the same manner as described above, starts the processing that adds the coordinate data of the electronic pen 3 to the end of the stroke data. More specifically, in the writing of a series of information, when the coordinate data of the electronic pen 3 temporarily moves from inside the effective area P to outside the effective area P, and once more returns inside the effective area P, the CPU 21 treats the coordinate data that is outside the effective area P as invalid, and generates two independent sets of stroke data from the coordinate data inside the effective area P.

Further, as shown in FIG. 4, when the CPU 21 receives the pen down signal (yes at step S13) while the CPU 21 is repeating the processing from step S11 to step S15 and standing by, when the CPU 21 has acquired the coordinate data (step S17) and the coordinate data is outside the effective area P (no at step S21), the CPU 21 repeats the processing at step S13, step S17 to step S21 and step S31 and stands by, in the same manner as described above. Then, if the coordinate data of the electronic pen 3 enters inside the effective area P (yes at step S21), the CPU 21 generates the stroke header (step S25), and starts the processing that adds the coordinate data of the electronic pen 3 to the end of the stroke data. In other words, even if the user starts writing the information, using the electronic pen 3, from outside the effective area P, the CPU 21 waits until the coordinate data of the electronic pen 3 enters inside the effective area P. Then, the CPU 21 generates the stroke header when the coordinate data of the electronic pen 3 enters inside the effective area P, and starts the processing that adds the coordinate data of the electronic pen 3 to the end of the stroke data.

The following looks at stroke data M2 and M3 shown in FIG. 5 that is generated by the CPU 21 based on a character “S” written by the user on the paper medium 100 using the electronic pen 3. The user presses the pen down at a point H2 and starts to write the character “S.” The CPU 21 acquires coordinate data of the point H2 (step S17) based on the pen down signal (yes at step S13). As the point H2 is not inside the effective area P (no at step S21), the CPU 21 treats the acquired coordinate data as invalid and does not generate the stroke data. Thus, the CPU 21 returns the processing to step S13 and repeats the processing at step S13, step S17 to step S21 and step S31. The character “S” that the user starts writing from the point H2 enters into the effective area P at a point B1 (yes at step S21). At that time, the CPU 21 generates the stroke header (step S25), and adds the coordinate data to the stroke data (step S27). After that, the CPU 21 repeatedly performs the processing at step S13 and step S17 to step S29, and adds the coordinate data based on the trajectory of the electronic pen 3 to the stroke data. The character “S” that is written by the user temporarily moves outside the effective area P at a point B2 (no at step S21). The CPU 21 determines the stroke header (step S33) based on [Flg] set at step S29 (yes at step S31). The CPU 21 completes the stroke data M2 in this manner and returns the processing to step S11. [Flg] is set to False (step S11).

The user continues to write the character “S” without lifting the pen up while remaining outside the effective area P (yes at step S13, no at step S21). The CPU 21 repeats the processing at step S13, step S17 to step S21 and step S31, treats the acquired coordinate data as invalid and does not generate the stroke data. The character “S” written by the user once more enters the effective area P at a point B3 (yes at step S21). At that time, the CPU 21 generates the stroke header (step S25) and adds the coordinate data based on the trajectory of the electronic pen 3 to the stroke data, by repeating the processing at step S13 and step S17 to step S29 in a similar manner. The user lifts the pen up at a point F2 of the written character “S.” The CPU 21 determines the stroke header (step S33) based on the pen up signal (no at step S13), and completes the stroke data M3. In this manner, the CPU 21 generates the two sets of stroke data M2 and M3 as a result of the fact that the character “S” written by the user moves outside the effective area P during the writing. The stroke data M2 and M3 are each formed by the coordinate data inside the effective area P.

As explained above, the CPU 21 of the information input device 1 of the present embodiment does not add the coordinate data to the stroke data when the coordinate data of [NowPoint] is outside the effective area P. Specifically, even if the CPU 21 acquires, from the ASIC 28A and the ASIC 29A, the coordinate data based on a result of a position detected by the sensor boards 71 and 72 that is inside the ineffective area D or is further to the outside of the ineffective area D (outside the detection areas 71A and 72A), the CPU 21 does not include that coordinate data in the stroke data. When the electronic pen 3 is positioned outside the detection areas 71A and 72A, depending on a sensitivity of the sensor boards 71 and 72, the CPU 21 may acquire coordinate data representing a trajectory that is not intentional by the user. However, with the configuration of the present embodiment, this type of coordinate data is not included in the stroke data and thus it is possible to generate the accurate stroke data. Further, by including the coordinate data inside the ineffective area D in data to be excluded from the stroke data information, it is possible to further improve the accuracy of the stroke data.

In addition, when the writing using the electronic pen 3 is initially performed inside the effective area P, temporarily moves outside the effective area P and is then once more performed inside the effective area P, there is a case in which, in the stroke data, the coordinate data immediately before moving outside the effective area P from inside the effective area P, and the coordinate data immediately after moving inside the effective area P from outside the effective area P are treated as continuous data. In this case, depending on an application using the stroke data, it is possible that the coordinate data immediately before moving outside the effective area P from inside the effective area P and the coordinate data immediately after moving inside the effective area P from outside the effective area P may be connected by a line segment, or the like, that connects the two sets of coordinate data in a straight line. Thus, by independently forming the stroke data for each set of a series of coordinate data based on the writing performed inside the effective area P, it is possible to more accurately reproduce the trajectory of the electronic pen 3 that is reproduced by the stroke data.

In addition, by adding the stroke header to the stroke data, the information input device 1 can generate the stroke data as the single independent information and not simply as the aggregate of the coordinate data.

Further, the CPU 21 acquires the coordinate data output by the ASIC 28A and the ASIC 29A during the period from when the CPU 21 receives the pen down signal to when the CPU 21 receives the pen up signal. In addition, the CPU 21 stores the acquired coordinate data based on the result of the determination as to whether the coordinate data is included in the effective area P. As a result, the CPU 21 obtains the stroke data from which the unnecessary coordinate data is excluded. In this manner, the accuracy of the stroke data can be even further improved.

It should be noted that the present disclosure is not limited to the above-described embodiment, and various modifications are possible. For example, in the above-described embodiment, the CPU 21 generates the stroke header when the coordinate data based on the trajectory of the electronic pen 3 enters into the effective area P from outside the effective area P. However, the present disclosure is not limited to this mode. For example, the CPU 21 may constantly prepare to generate the stroke data by generating the stroke header in the processing at step S11. In this case, it is possible to omit the determination processing at step S23, and it is thus possible to reduce the load on the CPU 21 in the execution of the main processing.

Further, in the above-described embodiment, the information input device 1 uses the known electromagnetic induction method to detect the position at which the electronic pen 3 approaches. However, the information input device 1 may use a resistive membrane method (a so-called pressure-sensitive method), an electrostatic capacitance method or another method to detect the approach or the contact of the electronic pen 3 on the housings 8L and 8R that house the sensor boards 71 and 72. Further, the structure, the size, the format and the material etc. of the paper medium 100 are not limited to the above-described embodiment.

In addition, the ASIC 28A and the ASIC 29A generate the coordinate data based on the position of the electronic pen 3 detected by the sensor boards 71 and 72 and output the coordinate data to the CPU 21 of the main board 20. However, the present disclosure is not limited to this mode. For example, the ASIC 28A and the ASIC 29A may perform voltage conversion on the electric current flowing through the loop coils of each of the sensor boards 71 and 72, perform A/D conversion on an obtained voltage value and output the converted voltage value to the CPU 21. The CPU 21 may generate the coordinate data based on the voltage value obtained from each of the ASIC 28A and the ASIC 29A.

A “processor” of the present disclosure is not limited to the CPU 21. That is, it goes without saying that an ASIC or a field programmable gate array (an FPGA) can be favorably used as the “processor” of the present disclosure, in place of the CPU 21. Alternatively, it goes without saying that a computer that is connected to the information input device 1 can be favorably used as the “processor.”

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. An information input device comprising:
a sensor portion configured to generate an output corresponding to a position of a writing tool inside a predetermined detection area, in the course of writing that is performed on a recording medium using the writing tool, the recording medium being set on the information input device such that the recording medium corresponds to the detection area; and
a processor configured to perform processes comprising:
acquiring position information based on the output of the sensor portion, the position information being information corresponding to the position of the writing tool;
storing trajectory information in a storage medium, the trajectory information corresponding to a trajectory of writing performed using the writing tool, and being formed of a series of the position information as a result of chronologically storing the acquired position information in the storage medium;
determining whether the position of the writing tool corresponding to the acquired position information is included in a second area, which is an area obtained by excluding a first area from the detection area, the first area being an area of a predetermined width along an outer edge of the detection area;
prohibiting processing that adds the acquired position information to the trajectory information and stores the updated trajectory information, when it is determined that the position of the writing tool corresponding to the acquired position information is not included in the second area; and
performing processing that adds the acquired position information to the trajectory information and stores the updated trajectory information, when it is determined that the position of the writing tool corresponding to the acquired position information is included in the second area.

2. The information input device according to claim 1, wherein the processor is further configured to perform processes comprising:
storing in the storage medium, as the single independent trajectory information, a set of a series of the position information which is continuously acquired and for which the position of the writing tool corresponding to the position information is determined to be inside the second area.

3. The information input device according to claim 2, wherein the processor is further configured to perform processes comprising:
adding attribute information, which is information representing attributes of the trajectory information and which includes at least information indicating a number of the position information, to each of the sets of the series of position information.

4. The information input device according to claim 1, wherein the processor is further configured to perform processes comprising:
receiving a first signal output by the sensor portion when the writing tool touches or comes close to the detection area, and a second signal output by the sensor portion when the writing tool has separated from the detection area; and
performing processing that adds the acquired position information to the trajectory information and stores the updated trajectory information, when it is determined that the first signal is received and the position of the writing tool corresponding to the acquired position information is included in the second area.
